(19) United States
(12) Patent Application Publication
(10) Pub. No.: US 2025/0363915 A1
(43) Pub. Date: Nov. 27, 2025

(54) PORTABLE ILLUMINATED SIGN

(71) Applicant: SMARTREND MANUFACTURING GROUP (SMG), INC., Winnipeg, Manitoba (CA)

(72) Inventors: Michael YUDELEVICH, Winnipeg (CA); Kevin Peter SMITH, Winnipeg (CA); Vladimir KOTLYAR, Winnipeg (CA)

(21) Appl. No.: 18/851,921

(22) PCT Filed: May 10, 2024
(86) PCT No.: PCT/CA2024/050633

§ 371 Date: Sep. 27, 2024

Related U.S. Application Data
(60) Provisional application No. 63/501,819, filed on May 12, 2023.

(51) Int. Cl. G09F 13/04; F21L 4/02; F21V 5/00; F21V 7/04; F21Y 115/10

(52) U.S. Cl. CPC G09F 13/0422; F21L 4/02; F21V 5/002; F21V 7/04; G09F 13/0463; G09F 13/0472; F21Y 2115/10; G09F 13/0445

(57) ABSTRACT

A portable illuminated sign is disclosed. The sign includes a sign portion, the sign portion comprising indicia, and an internal light source comprising one or more LEDs in edge-lighting relationship with a diffuser panel underlying a visible area of the indicia to be illuminated; and a handle affixed to the sign portion, the handle comprising a power source for the internal light source.

### FIELD

The present disclosure relates to portable illuminated signs. In particular, the present disclosure relates to portable illuminated traffic signs.

### BACKGROUND

Portable traffic signs, such as handheld or pole-mounted signs, may have a variety of uses. For example, a handheld or pole-mounted stop sign may be used by crossing guard or construction workers to control the flow of traffic at a cross-walk or near a construction site, respectively. Such signs are sometimes referred to as traffic paddles. Since failure to obey such signs could result in serious injury or even loss of life, there is a desire to improve the visibility of such signs, particularly in low light conditions.

### BRIEF DESCRIPTION OF THE DRAWINGS

Embodiments will be described, by way of example only, with reference to the accompanying figures wherein:

FIG. 1 is a front perspective view showing a sign according to one embodiment of the present disclosure.

FIG. 2 is a back perspective view of the sign of FIG. 1.

FIG. 3 is an exploded view of a sign portion of the sign of FIG. 1.

FIG. 4 is an internal view of the handle of the sign of FIG. 1.

FIG. 5 is a partially exploded view of the handle of FIG. 4.

FIG. 6 is a front perspective view showing a sign according to another embodiment of the present disclosure.

FIG. 7 is an exploded view of a sign portion according to embodiments of the present disclosure.

FIG. 8 is a front perspective view of a double-sided sign having a visor according to embodiments of the present disclosure.

FIG. 9 is a front perspective view of a single-sided sign having a visor according to embodiments of the present disclosure.

FIG. 10 is an exploded view of a further embodiment of a sign portion of a sign according to embodiments of the present disclosure.

FIG. 11 is a sectional perspective view of an embodiment of a light concentrator according to the present disclosure.

FIG. 12 is a side view of FIG. 11.

FIG. 13 is a sectional perspective view of a further embodiment of a light concentrator according to the present disclosure.

FIG. 14 is a side view of FIG. 13.

FIG. 15 is a sectional perspective view of a further embodiment of a light concentrator according to the present disclosure.

FIG. 16 is a side view of FIG. 15.

FIG. 17 is a font perspective view showing a sign according another embodiment of the present disclosure.

FIG. 18 illustrates a sign according to another embodiment of the present disclosure.

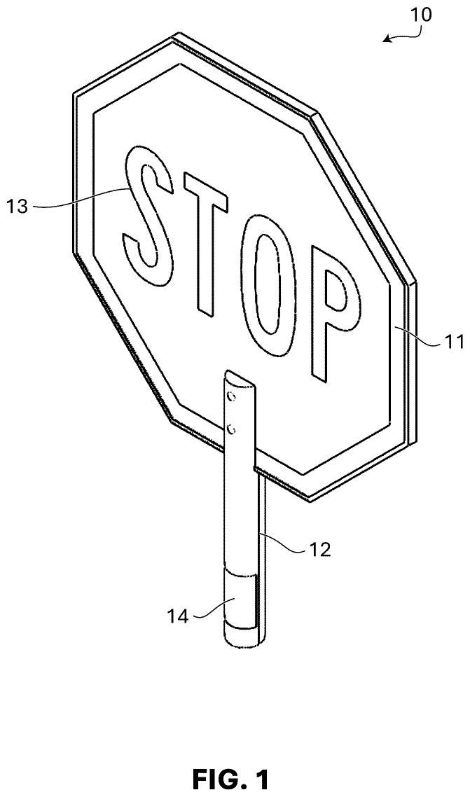

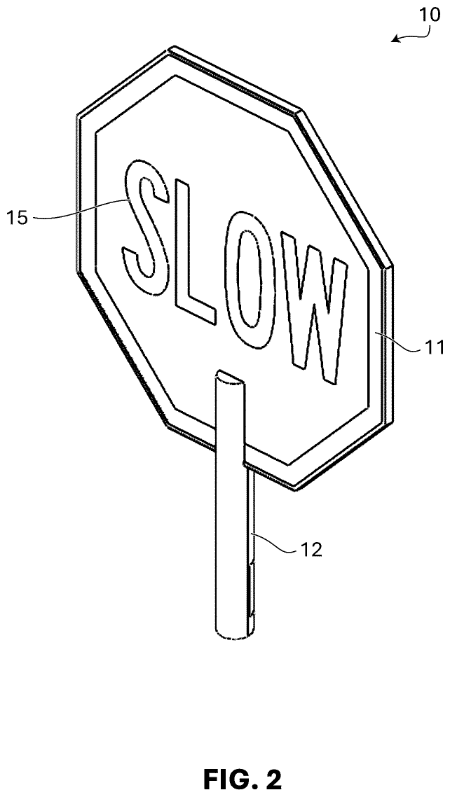

### DETAILED DESCRIPTION

The present disclosure relates to portable signs, for example stop signs and other traffic or warning sings. Such signs are often double-sided with either identical or different indicia on each side. By way of example only, one side of the sign may indicates the word STOP while the other side indicates the word SLOW. A basic and simple construction of such a sign currently includes a metallic plate held as a paddle with the desired signage on opposing sides of the plate. However, such traffic paddles are difficult to make out in low light conditions, particularly by approaching drivers.

Various means are currently employed to improve visibility of such signage. For example, currently available portable or handheld signage may include a retroreflective outer surface. Such a surface may reflect light emitted from car headlights and other sources to improve visibility of the sign surface, but also has limitations. For example, in the absence of a light source or a properly angled light source, a retroreflective layer would not achieve the desired effect. In addition, some currently available signage may include individual lights spaced around a perimeter of the sign or on the sign surface to act as flashers, beacons or simply lights to attract attention. In some cases, just the word STOP or other words may be illuminated from within the sign.

However, these approaches do not provide for a complete or near complete illumination of the entire sign surface that is sufficient to be seen at a distance, in low light conditions, through the elements such as rain or fog, etc.

Moreover, because such portable signage is typically being held during use or, at a minimum, must be capable of being relatively easy to hold and manipulate, it is desirable to minimize the weight of such a sign, while providing for a sufficient size and illumination.

Thus, embodiments according to the present disclosure provide a portable sign where a substantial or entire surface of the sign is illuminated from an internal illumination source. In some embodiments, the sign is double-sided, with both sides being illuminated.

For example, some embodiments provide for a double-sided illuminated sign. The illuminated sign is affixed to a handle or pole. The handle or pole contains a power source to provide power to the sign. The sign may include the same or different indicia on each side of the sign. In addition, each side or indicia may be retroreflective. The sign is illuminated from an internal illumination source, for example using LEDs in edge-lighting technology. However, other internal illumination may be possible. The construction and configuration of the sign provides for a sufficiently compact size and reduced weight for use as a portable sign. The configuration of the internal illumination provides substantially uniform light distribution across the surface of the sign and low power consumption in comparison to other illuminating technologies.

Referring to the figures, embodiments of a portable illuminated sign will now be described in greater detail. A handheld sign 10 comprises a double-sided illuminated sign portion 11, with first indicia 13 capable of being illuminated when the sign 10 is activated. The double-sided illuminated sign portion 11 is affixed to handle 12. The handle 12 length may vary, based on the application and power storage requirements. In some embodiments, the handle 12 may be sufficiently long to act as a pole and allow a user to rest the sign on the ground while still having sign portion at a desired height. In some embodiments, a pole may be removably attached to the handle. The handle may be exchangeable between handles or poles of varying length, or the handle may be configured to be adjustable in length, for example telescopically. The handle 12 may include cover 14 to allow access to a cavity containing the power source, for example one or more batteries.

The sign portion 11 may have the same or different indicia on either side. As shown in the illustrated embodiment, the first indicia 13 show a stop sign with the word STOP surrounded by a background and a border. The second indicia 15 show a slow sign with the word SLOW surrounded by a background and a border. Moreover, the sign portion 11 is shaped as an octagon as that is a standard shape and size for a typical stop sign. However, other indicia, as well as other shapes of the sign portion (square, round, etc.) are possible and within the scope of the present disclosure.

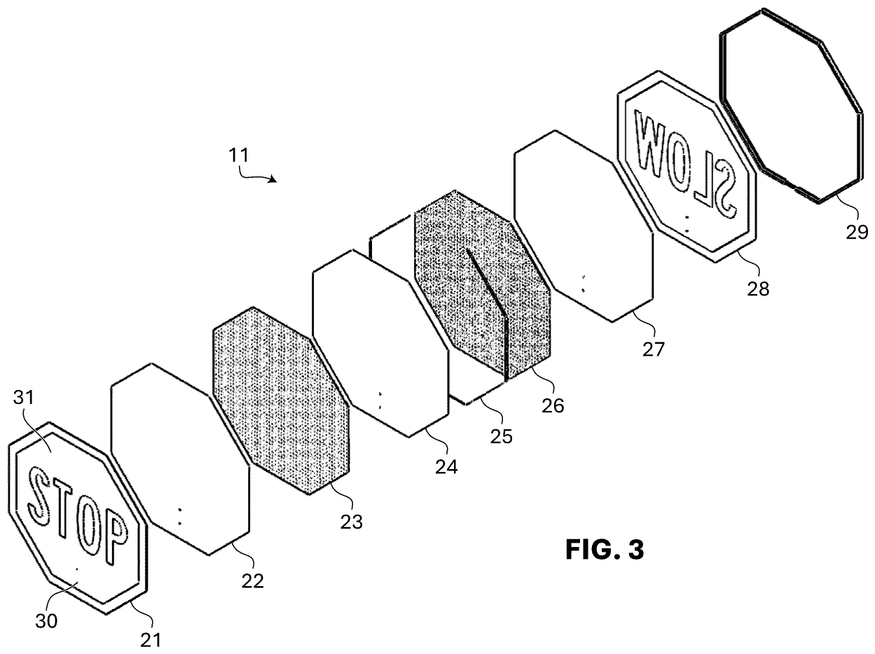

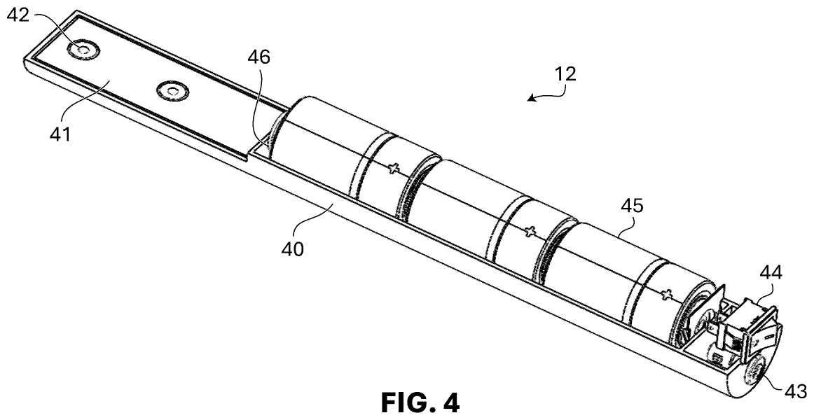

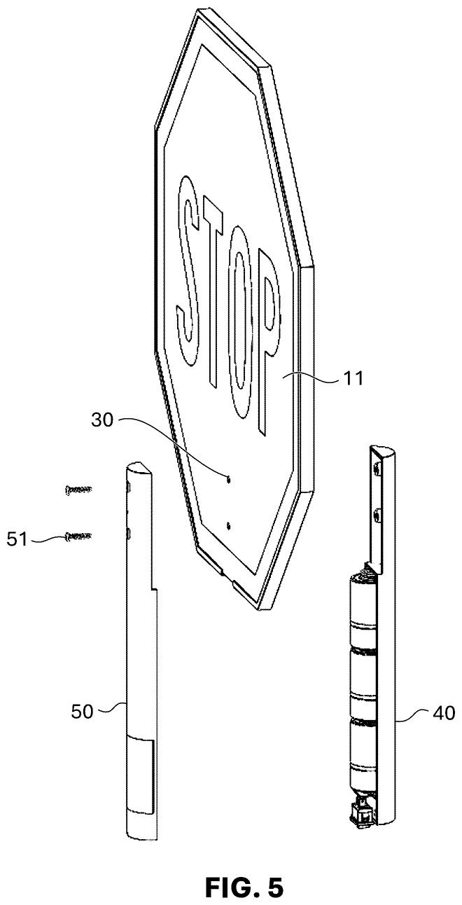

Referring to FIG. 3, one embodiment of the internal construction of a sign portion 11 will be described. In the illustrated embodiment, the sign portion 11 is comprised of a sandwich construction of multiple components or layers. Light reflector 24 is located at the center of the sign portion 11 and is made of a low light absorption material, for example, high gloss opaque PET film. Opposite surfaces of the light reflector 24 have the same light reflective properties and reflect light outwards, away from the center.

A first light diffuser 23 is affixed to the front side of the light reflector 24, while on an opposite side of the light reflector 24, a second light diffuser 26 is affixed to the back side of light reflector 24. Both the first and second light diffusers 23 and 26 contain a light dispersive pattern that evenly distributes illumination throughout the surface of the light diffuser. Front indicia carrier 22 is affixed to a side of the first light diffuser 23 facing away from the light reflector 24. Similarly, back indicia carrier 27 is affixed to a side of the second light diffuser 26 facing away from the light reflector 24. As shown in the illustrated embodiments herein, the indicia carriers may be configured as panels. The indicia carrier(s) may have the same shape and/or size as the diffuser.

Front indicia 21 is affixed to indicia carrier 22 on a side facing away from the first light diffuser 23. Similarly, back indicia 28 is affixed to the back indicia carrier 27 on a side facing away from the second light diffuser 26. Both indicia 21 and 28 may be retroreflective.

In the illustrated embodiment, the indicia 21 and 28 may be configured as decals applied to the indicia carriers. In other embodiments, the indicia 21 and indicia carrier 22 may be combined into one component. Similarly, indicia 28 and indicia carrier 26 can be combined into one component. In some embodiments, the indicia may be printed onto the indicia carrier. The indicia carriers may be transparent or translucent. The indicia may have different degrees of translucency. The indicia may be a combination of decals adhered to the indicia carrier and indicia printed on or embedded in the indicia carrier.

A light source 25 is provided to generate internal illumination. In the illustrated embodiment, the light source 25 is comprised of a plurality of LED elements arranged in an edge-lighting configuration and configured to emit light into edges of the diffusers 23 and 26. Specifically, the light emitted form the light source 25 is diffused inside light diffusers 23 and 26, reflected from light reflector 24 and exits through indicia carries 22 and 27 and indicia 21 and 28.

The LED elements may be positioned on one or more LED strips positioned along a perimeter of the light reflector 24 such that a portion, for example approximately half, the light generated by the LEDs is transmitted into each diffuser 23 and 26. In other embodiments, a single strip may have multiple rows of LEDs side-by-side such that an equal plurality are positioned on either side of the light reflector 24 and all the light generated by each plurality is intended for a single diffuser. In some embodiments, each diffuser may have a respective set of LEDs arranged in edge lighting relationship there with. In yet other embodiments, one or more LEDs may be embedded in the diffuser. The LEDs are not necessarily arranged along an entire perimeter of the light reflector and/or diffusers. The LEDs may be positioned along only a portion of the perimeter.

As shown in the illustrated embodiments herein, the diffuser may be configured as a panel. The panel may have the shape of the visible area to be illuminated when the sign is operated. At a minimum, the diffuser underlies the area to be illuminated.

A sealing rim or frame 29 holds the sign portion 11 together and provides water and dust ingress protection, i.e. providing a weather tight seal to the sign portion 11. Additional components, such as weather stripping, may be included to provide a further or improved weather tight seal. An interior shape or outline of the frame defines the shape of the indicia and a visible area 31 of the sign portion 11 that is illuminated during operation. In the illustrated embodiment, the frame 29 has a generally octagonal shape. Other shapes are possible as noted above.

The frame 29, as is the case for other frames of the sign discussed herein, forms an outer perimeter of the sign portion. The frame may surround all or a significant portion of the sign portion. In some embodiments the handle of the sign may define a portion of the visible area 31 of the indicia that is illuminated. In some embodiments the frame is connected to the handle. Thus, the handle may form part of the frame in some embodiments and might assist in sealing the sign portion.

In some embodiments, one or more layers of the sign, e.g. layers within the “sandwich” construction of the sign, may be attached to each other utilizing double sided tape between the layers applied to the surface adjacent to the edge of each layer. In this case a sealing rim 29 will only provide water and dust ingress protection.

Components 21, 22, 23, 24, 26, 27, and 28 have through holes 30 to allow mounting of handle 12 to the sign portion 11. Other means of attaching the components to the handle are also possible and within the scope of the present disclosure.

Handle 12 comprises a main body 40, with compartment 46 that contains batteries 45. Connector 43 is attached to main body 40 and can receive power to illuminate the sign portion 11 or charge batteries 45. On/Off switch 44, turns the sign portion 11 on or off. Electronic controller 41 controls the illumination of the sign portion 11, provides protection to the lighting elements, e.g. LEDs, thereof and controls the charging of the batteries 45. Embosses 42 receive screws that clamp the handle 40, the sign portion 11 and handle cover together.

For example, the screws 51 are inserted through corresponding holes in a handle cover 50, through openings 30, in the sign portion 11 and clamped into embosses 42 inside the handle main body 40.

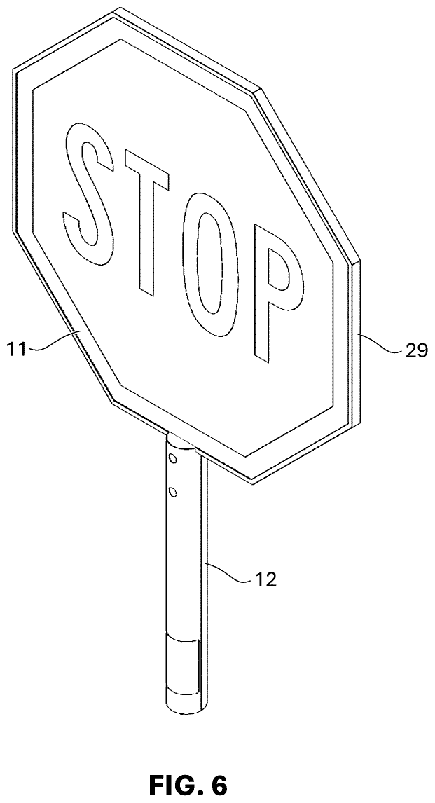

Other embodiments of connecting the handle to the sign portion are possible. FIG. 6 shows another embodiment where handle 12 is attached to a rigid frame of the sign portion, for example frame 29, without obscuring any of the indicia at the front and/or back of the sign portion 11.

Embodiments of the present disclosure also cover a single sided illuminated sign. Such embodiments may also have a layered construction. Referring to FIG. 7, a light reflector 64 may be included. The light reflector 64 may be comprised of a low light absorption material, for example, high gloss opaque PET film. A light diffuser 63 is affixed to the front side of light reflector 64. The light diffuser 63 contains a light dispersive pattern that evenly distributes illumination throughout a front surface thereof. An indicia carrier 62 is affixed to the light diffuser 63. Indicia 61 are affixed to the indicia carrier 62. The indicia 61 may be retroreflective. The indicia 61 and indicia carrier 62 may be combined into one component. An opaque back cover 66 provides mechanical protection to the back side of the sign unit.

A light source 65 comprising a plurality of LED elements emit light into edges of the light diffuser 63. Light emitted from the light source 65 is diffused inside the light diffuser 63, then reflected from light reflector 64 and exits through indicia 62.

A frame 67 holds the sign unit together and provide water and dust ingress protection. The frame 67 defines a visible area 69 of the sign portion that is illuminated during operation.

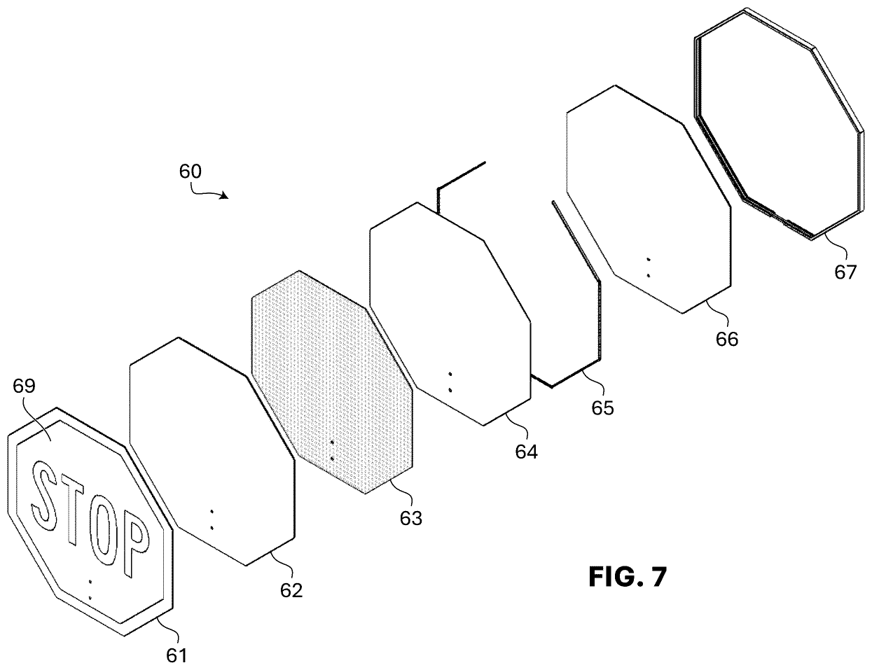

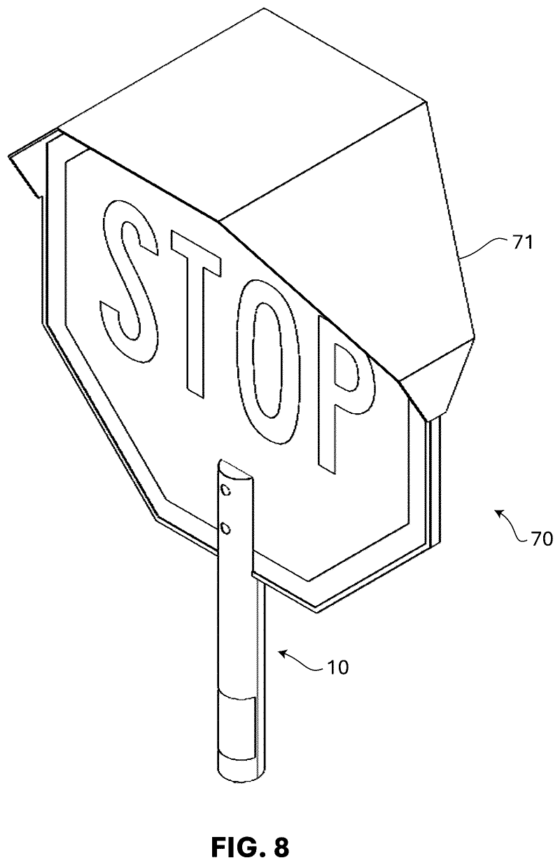

As shown in FIGS. 8 and 9, in some embodiment, the sign may include a separate, affixed or integrated visor.

A portable sign assembly 70 may include a double-sided illuminated sign 10, and double-sided visor 71. The visor 71 may be a separate visor affixed to the outer frame or another portion of the sign 10 or may be integrated into the frame or other portion of the sign 10.

A handheld sign assembly 80 may include a single-sided illuminated sign 82 and single-sided visor 81. The visor 81 may be a separate visor affixed to the outer frame or another portion of the sign 82 or may be integrated into the frame or other portion of the sign 82.

The visors 71 and 81 may improve use of the sign in a wide variety of environmental conditions. For example, during bright light the visor may block the sun and make light emitted from the sign unit more noticeable. During snowfall the visor may protect the indicia from being obscured by the snow, etc.

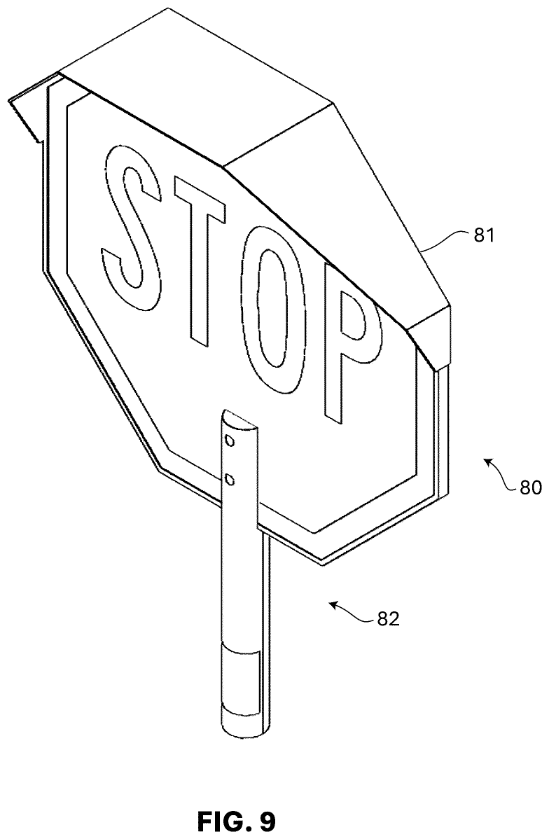

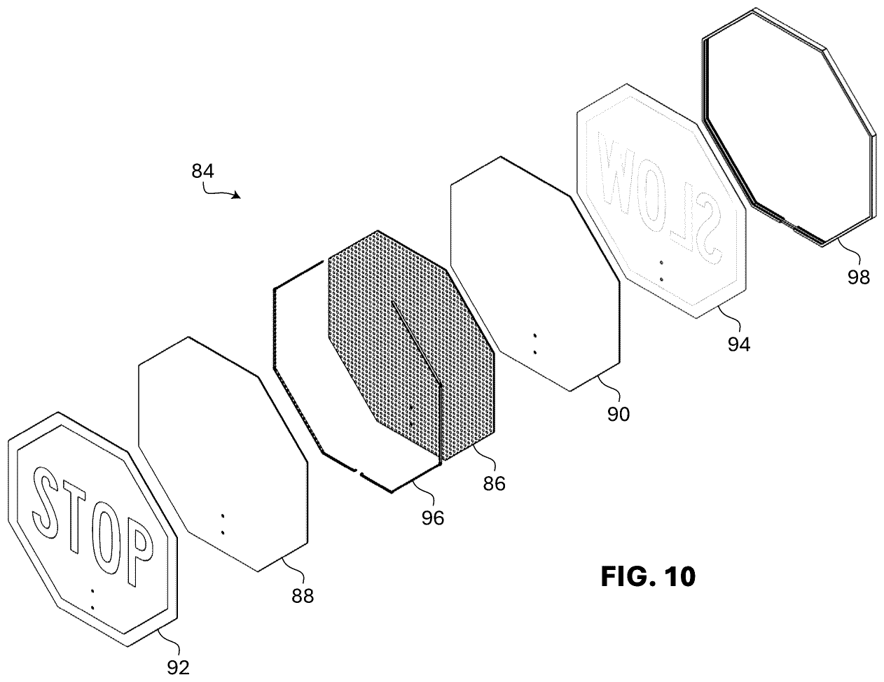

Referring to FIG. 10, a further embodiment of a sign portion 84 according to the present disclosure will be described. Sign portion 84 includes, in a sandwich construction, a diffuser 86, indicia carriers 88 and 90, each positioned on opposing sides of the diffuser 86, and indicia 92 and 94, each positioned on a respective one of the indicia carriers 88 and 90. The diffuser 86 may consist of an acrylic panel with printed dot pattern to achieve a desired homogeneous distribution of light diffusion. Indicia carriers 88 and 90 may each consist of a polycarbonate panel. The indicia 92 and 94 may be printed on a retroreflective material applied to the indicia carriers. Other options for the construction of the indicia carriers and indicia are possible and within the scope of the present disclosure.

LED strip or strips 96 are in edge lighting relationship with the diffuser 86, with frame 98 surrounding the construction and providing stability and/or appropriate weather tight sealing. LED strips 96 may not surround or extend along the entire perimeter of the diffuser 86. In the illustrated embodiment, the LED strips extend along or parallel to only seven of the eight sides of the octagon-shaped diffuser 86. As in other embodiments discussed above, other options for weather sealing may be provided. The individual layers in the sandwich construction may be adhered to each other using double-sided tape. The frame 98 defines a visible area of the indicia 92 that is illuminated when the sign is operated.

While FIG. 10 shows a double-sided sign construction. A single-sided sign construction could use similar components but replace one side of the construction with a non-transparent back plate and/or reflector to ensure all light diffused from the diffuser is reflected outward through the desired visible area of the indicia that is illuminated during operation.

Other principles and disclosure relating to the construction of the sign portion, as well as the portable sign as a whole (e.g. principles relating to the construction, shape, sizing of the sign, as well as how a handle might be connected to the sign portion) apply equally to the sign portion 84.

Depending on the desired size of the portable sign, the weight of the sign might affect the ability of some users to hold the sign for the desired amount of time during use. One option may be to add a pole, as discussed above, to help support the weight of the sign. Instead or in addition, the present disclosure presents embodiments that allow for a possible reduction in the thickness of components of the sign, primarily the diffuser(s), thus allowing for the sign portion to be thinner and lighter.

In particular, LED strips, which consist of individual LEDs on PCB strips, comprise a minimum width, under which it is not currently possible to produce LEDs with the desired brightness. If the diffuser, which is in edge lighting relationship with the LED strips, is sized to be thinner than the minimum width of the LED strips, some light generated by the LEDs might not propagate into the diffuser, thereby being effectively lost in illumination of the visible area of the indicia. Thus, in such cases, a light concentrator may be included to concentrate the light emitted by the LEDs into the diffuser to reduce or eliminate loss.

Moreover, even where a thickness of a diffuser matches or is greater than the width of the LEDs, a light concentrator may be beneficial. This is because light rays emitted by the LEDs are emitted in a spherical distribution, resulting in some rays impinging on a side or edge of the diffuser with an angle greater than the critical angle of reflection, resulting in those rays being reflected and lost instead of entering the diffuser. Thus, even in such circumstances, a light concentrator may aid in ensuring a higher proportion of the emitted light is used to illuminate the sign.

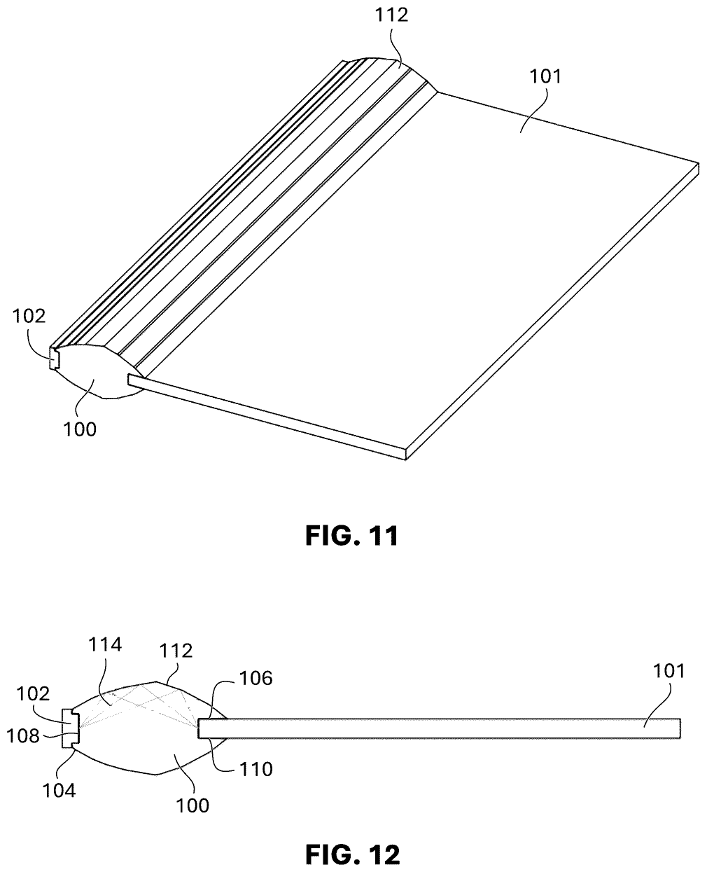

Referring to FIGS. 11 to 16, embodiments of light concentrators will be described that may be implemented in one or more embodiments of the portable sign according to the present disclosure.

FIG. 11 illustrates a section of a light concentrator 100 positioned between an LED or panel 102 (e.g. a PCB with LEDs soldered thereon) and a diffuser 101, e.g. the diffuser 86. The light concentrator 100 is configured as rod, bar etc. extending in a lengthwise direction with an approximately elliptic cross-sectional profile with a first end 104 and a second end 106. The first end 104 may have a groove, slot, indent etc. 108 that is sized to receive the LEDs. The second end 106 may have a groove, slot, indent etc. 110 that is sized to receive an edge or portion of the diffuser 101. As shown in the illustrated embodiment, the elliptic surfaces extending from the first end 104 to the second end 106 may be faceted with one or more facets 112. In the illustrated embodiments, multiple of the facets 112 extend along the light contractor 100 in the lengthwise direction.

As seen in FIG. 12, the facets 112 are configured and arranged such that light emitted from the LEDs are internally reflected within the light concentrator and directed towards an edge of the diffuser 101. This is indicated by the schematic representation of light rays 114 being shown as emanating from the LEDs and being internally reflected towards the diffuser 101. A variety of configurations and arrangements of the facets 112 to achieve the stated result are possible and within the scope of the present disclosure. The set of facets 112 may be chosen in such a way that any rays emitted by the LEDs fall on the surface by an incident angle bigger than critical and are fully reflected in such a way that it is diverted into the diffuser.

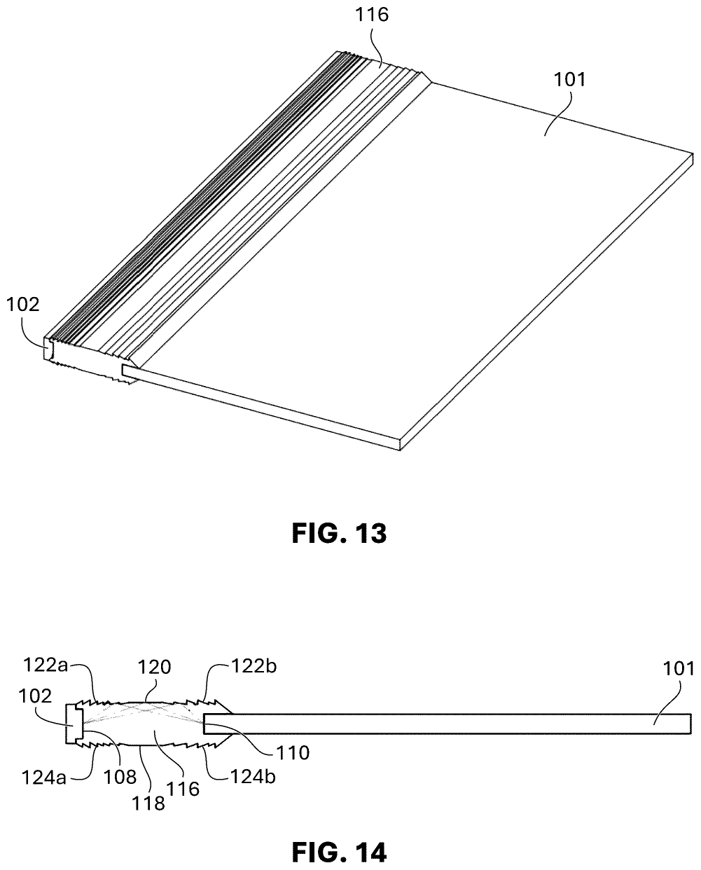

FIG. 13 and FIG. 14 illustrate a section of a further embodiment of a light concentrator 116. Features of the embodiment of FIG. 13 and FIG. 14 that are equivalent to the features of the embodiment of FIG. 11 are given like reference numerals. The light concentrator 116 has a generally rectangular cross-section with first side 118 and second side 120. Two sets of facets 122a and 122b are positioned on the first side 118 and two sets of facets 124a and 124 b are positioned on the second side 118. Each group of facets on one side (i.e. 122a and 122b or 124a and 124b) are arranged in a saw tooth pattern, with the groups facing each other acting as a form of internal linear Fresnel reflector. This arrangement may help ensure that any rays emitted by the LEDs are internally reflected and are diverted into the diffuser. Use of the Fresnel principles may aid in reducing the amount of material needed for the light concentrator 116 as compared the light concentrator 100.

Other configurations for the light concentrators are possible as well, for example using other reflection principles. In some embodiments, dielectric mirrors may be used and/or other mirrors, such as metal polished mirrors.

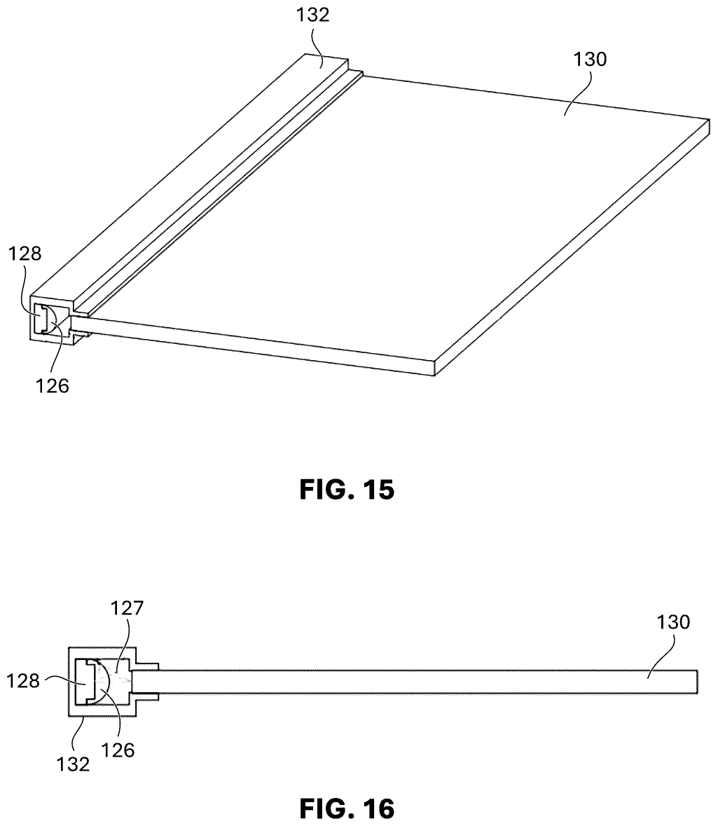

Referring to FIGS. 15 and 16, in some embodiments a refracting element 126 may be positioned between an LED or panel 128 (e.g. a PCB with LEDs soldered thereon) and a diffuser 130, e.g. the diffuser 86. In the illustrated embodiment, the refracting element 126 has a curved side, which may be curved parabolically or otherwise, to assist in focusing the light rays 127 emitted from the LEDs onto the edge or side of the diffuser 130. The refracting element 126 may be positioned in contact with the LED or with a gap therebetween.

A structural support 132 houses the LEDs 128 and the refracting element 126 and provides support for the diffuser 130. Other configurations of such a support are possible and not limited to the illustrated embodiment. The structural support may be produced from various rigid materials (e.g. aluminum, plastic, etc.) and may be made by extrusion. The structural support could be used to aid in dissipating heat generated by the LEDs. The structural support could adjust the focal distance between the diffuser and the refracting element.

In some embodiments, the diffuser may be thicker or thinner than the minimum width of the LEDs.

A light concentrator according to the present disclosure may be incorporated into embodiments of the sign along some or all of the perimeter of the sign portion where LEDs are positioned to emit light. The frame and/or handle may conceal the light concentrator. The frame and/or handle may be sized and configured to accommodated the light concentrator therein.

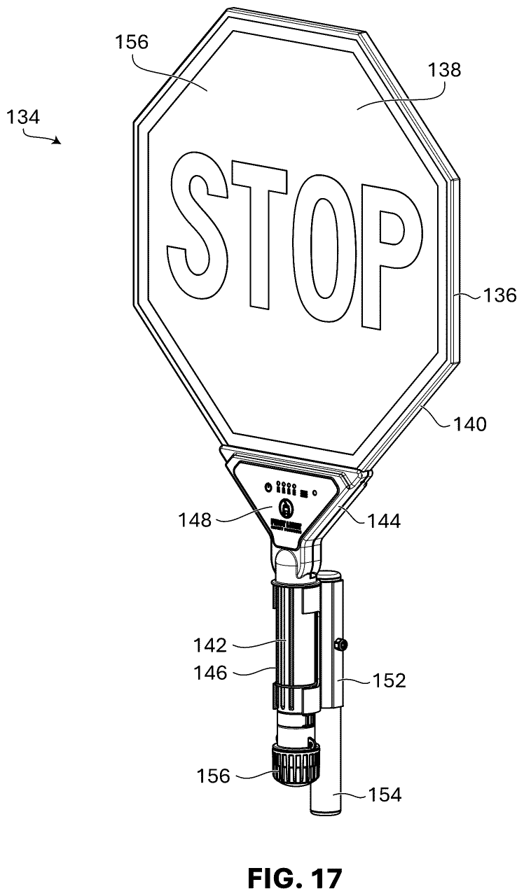

Referring to FIG. 17, another embodiment of a sign 134 according to the present disclosure will be described. The sign portion 136 may have an internal construction or configuration according to embodiments of the present disclosure described herein. In the illustrated embodiment, indicia 138 are surrounded by a frame 140. A handle 142 includes a base portion 144 that, in the illustrated embodiment, is formed by a triangular housing and a handle portion 146. The base portion 144 is positioned between the sign portion 136 and the handle portion 146. The base portion houses a controller and electronics (not shown) to regulate, for example, brightness of the sign. Multiple controls (e.g. on/off button, etc.) are located on a surface 148 of the base portion 144. In the illustrated embodiment, battery strength indicator lights are also located on the surface 148 of the base portion 144. The base portion 144 may form part of the frame 140 along a portion of the perimeter of the sign portion 136 and, together with the remainder of the frame 140, defines a visible area 156 of the indicia 138 that is illuminated when the sign 134 is operated.

The handle portion 146 houses a power source, such as rechargeable batteries. A pole mount 152 is affixed to the handle 142 to allow pole 154 to be inserted and used with the sign 134 (only a portion of the pole is shown in FIG. 17). The pole mount 152 may be removed if the sign 134 is to be used as a handheld paddle without resting it on a pole.

A cap 156, such as a screw cap, may be used to close the battery compartment at the end of the handle 142.

Other embodiments are possible. For example, the base portion of the handle may be shaped or configured differently. The base portion may be shaped similar or continuous with the handle portion so that it is not readily clear to a user what portion is the base portion and what portion is the handle portion with the entire handle appearing as a common element. In single-sided embodiments of the sign, the controller, electronics and/or controls may be positioned on a rear, non-illuminated side of the sign and not in a portion of the handle.

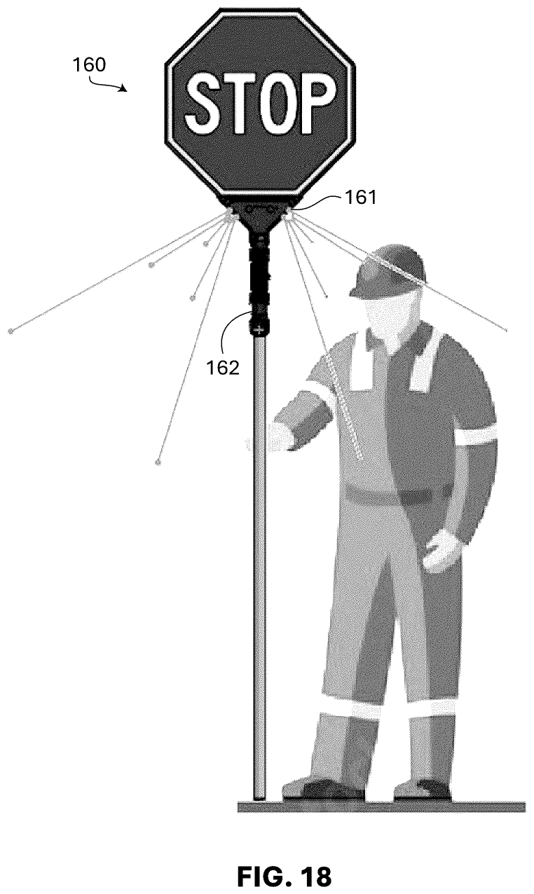

As illustrated in FIG. 18, in some embodiments, a sign 160 according to embodiments of the present disclosure, may include one or more lights 161 on a handle 162 of the sign 160 in order to illuminate a user.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms “approximately,” “about.” “substantially” and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Moreover, it will be understood that features of one embodiment may be combined with features of other embodiments, even if not expressly recited or described as a combination.

1. A portable illuminated sign, comprising:
a sign portion, the sign portion comprising indicia, and
an internal light source comprising one or more LEDs in edge-lighting relationship with a diffuser panel underlying a visible area of the indicia to be illuminated: and
a handle affixed to the sign portion, the handle comprising a power source for the internal light source.

2. The sign of claim 1, the internal light source further comprising a reflector panel positioned adjacent the diffuser panel for reflecting light emanating from the diffuser towards the indicia.

3. The sign of claim 2, further comprising a further diffuser panel and wherein the reflector panel is double-sided with two reflective surfaces facing away from each other, each of the two diffusers panels positioned adjacent a reflective surface of the reflector panel.

4. The sign of claim 1, further comprising an indicia carrier panel positioned between the indicia and the diffuser panel, the indicia affixed to the indicia carrier.

5. The sign of claim 4, wherein the indicia carrier panel and the diffuser panel have a common shape and size.

6. The sign of claim 4, wherein the indicia, the indicia carrier panel, and the diffuser panel have a common shape and size.

7. The sign of claim 1, wherein one or more weather tight seals are provided along a perimeter of the sign portion.

8. The sign of claim 1, wherein a weather tight sealing element spans a width of the sign portion and extends around a perimeter of the sign portion.

9. The sign of claim 1, wherein a light concentrator is positioned between the one or more LEDs and the diffuser panel to concentrate light from the LEDs into the diffuser panel.

10. The sign of claim 9, wherein the light concentrator has an elliptic profile.

11. The sign of claim 9, wherein the light concentrator has a one or more sides configured as an internal Fresnel reflector.

12. The sign of claim 9, wherein the light concentrator is faceted.

13. The sign of claim 9, wherein the light concentrator is configured as a refracting lens.

14. The sign of claim 9, wherein the light concentrator has a slot to receive the diffuser panel.

15. The sign of claim 9, wherein the light concentrator has a slot to receive the one or more LEDs.

16. The sign of claim 1, the sign portion further comprising a frame surrounding the indicia.

17. The sign of claim 16, wherein the frame defines the visible area of the indicia to be illuminated.

18. The sign of claim 16, wherein the frame seals the sign portion in a weather tight manner.

19. The sign of claim 16, wherein the handle is affixed to the frame.

20. The sign of claim 1, wherein the indicia comprise two indicia, each of the two indicia positioned on a respective opposite side of the diffuser panel.

21. The sign of claim 20, wherein a respective indicia carrier panel is positioned between each indicia and the diffuser panel, each indicia affixed to a respective indicia carrier panel.
